(19) United States
(12) Patent Application Publication
(10) Pub. No.: US 2025/0104201 A1
(43) Pub. Date: Mar. 27, 2025

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: SHINGO ISOBE, Kanagawa (JP)

(21) Appl. No.: 18/887,498

(22) Filed: Sep. 17, 2024

(30) Foreign Application Priority Data
Sep. 27, 2023 (JP) 2023-166226
Jun. 3, 2024 (JP) 2024-090281

(51) Int. Cl. G06T 5/70; G06T 5/50; G06T 5/60; G06T 7/80; G06T 7/90

(52) U.S. Cl. CPC G06T 5/70; G06T 5/50; G06T 5/60; G06T 7/80; G06T 7/90; G06T 2207/10024; G06T 2207/20081; G06T 2207/20084; G06T 2207/20216

(57) ABSTRACT

An image processing apparatus comprising: one or more memories storing instructions; and one or more processors executing the instructions to: execute image processing of an obtained input image via a trained model including a first parameter obtained by training on an image noise characteristic, reduce noise of an input image subjected to the image processing via a second parameter, combine the input image and an input image with the noise reduced on a basis of a third parameter, and in a case of changing one of the first parameter, the second parameter, and the third parameter, change and set a parameter to be changed on a basis of one of a control amount and preset reference data across a plurality of input images successively obtained.

### BACKGROUND OF THE INVENTION

### Field of the Invention

The present invention relates to an image processing apparatus, an image processing method, and non-transitory computer-readable storage medium.

### Description of the Related Art

There is a demand in the surveillance market for better visibility of subjects corresponding to targets in ultra-low light environments, and very high gain is applied when cameras captures images in an ultra-low light environment. By applying high gain, the captured image can be made brighter, but noise is also increased. The image quality does not need to be for viewing pleasure, but the visibility of the subject is important for use in surveillance.

To reduce the noise in captured images, noise reduction (NR) is typically used. NR processing may be executed inside the camera or may be executed on an image from a camera input into an image processing apparatus external to the camera. Also, noise reduction based on artificial intelligence technology using deep learning (DLNR) has become used recently. The effects produced by DLNR are better than those of known NR technology.

However, various types of image processing functions for captured images are a combination of different image processing, and various parameters are used in the various types of image processing. To obtain suitable image processing effects for capturing various scenes, combinations of image processing functions and parameters are held per scene, for example.

Japanese Patent Laid-Open No. 2020-109919 describes generating a prediction image using bidirectional gradient change processing that uses a gradient change between two interpolation images. This enables a viewer to see an image as if it has transitioned from a first state to a second state.

Japanese Patent Laid-Open No. 2007-288587 describes a technique for image quality adjustment for alleviating the sense that something is off by reducing sudden variation in the image quality when switching between scenes. With this technique, the parameters are incrementally changed from a parameter group A to a parameter group B. In Japanese Patent Laid-Open No. 2007-288587, examples of the image processing functions and parameters include brightness, sharpness, hue, color saturation, and the like.

However, with DLNR, when the parameters are switched, a shock may occur in the image. With Japanese Patent Laid-Open No. 2020-109919, when an interpolation image is generated from two images, an image that is different from the actual image is predictively generated, and when this prediction is different from reality, a shock occurs in the image. Also, with Japanese Patent Laid-Open No. 2007-288587, by just interpolating and applying from before transition A to after transition B, the transition goes through parameters that seem off in the image. There has been no mention relating to a parameter that is difficult to change incrementally such as in a trained model using DLNR.

### SUMMARY OF THE INVENTION

The present invention can reduce shock when switching a parameter of a DLNR trained model or the like or a strength parameter for reducing noise and can provide a high-quality image with a smooth NR effect applied.

According to one aspect of the present disclosure, there is provided an image processing apparatus comprising: one or more memories storing instructions; and one or more processors executing the instructions to: execute image processing of an obtained input image via a trained model including a first parameter obtained by training on an image noise characteristic, reduce noise of an input image subjected to the image processing via a second parameter, combine the input image and an input image with the noise reduced on a basis of a third parameter, and in a case of changing one of the first parameter, the second parameter, and the third parameter, change and set a parameter to be changed on a basis of one of a control amount and preset reference data across a plurality of input images successively obtained.

According to another aspect of the present disclosure, there is provided an image processing method comprising: executing image processing of an obtained input image via a trained model including a first parameter obtained by training on an image noise characteristic; reducing noise of an input image subjected to the image processing via a second parameter; combining the input image and an input image with the noise reduced on a basis of a third parameter; and in a case of changing one of the first parameter, the second parameter, and the third parameter, changing and setting a parameter to be changed on a basis of a control amount across a plurality of input images successively obtained.

According to another aspect of the present disclosure, there is provided a non-transitory computer-readable storage medium storing a computer program that when read and executed by a computer, causes the computer to execute image processing of an obtained input image via a trained model including a first parameter obtained by training on an image noise characteristic; reduce noise of an input image subjected to the image processing via a second parameter; combine the input image and an input image with the noise reduced on a basis of a third parameter; and in a case of changing one of the first parameter, the second parameter, and the third parameter, change and set a parameter to be changed on a basis of a control amount across a plurality of input images successively obtained.

Further features of the present invention will become apparent from the following description of exemplary embodiments (with reference to the attached drawings).

### BRIEF DESCRIPTION OF THE DRAWINGS

FIG. 1 is a block diagram illustrating the configuration of an image processing apparatus.

FIG. 2 is a flowchart of the image processing executed by the image processing apparatus.

FIG. 3 is a flowchart of the subroutine of an initialization processing of S100.

FIG. 4A is an explanatory diagram of a neural network for processing of an input image.

FIG. 4B is an explanatory diagram of a neural network for processing of an input image.

FIG. 5 is a flowchart of the subroutine of the image processing settings of S120.

FIG. 6 is a flowchart of the subroutine of the noise estimation processing of S130.

FIG. 7 is a diagram illustrating an example of flat portion region extraction.

FIG. 8A is an example of noise dispersion characteristic per camera setting.

FIG. 8B is an example of noise dispersion characteristic per camera setting.

FIG. 9 is a flowchart of the subroutine of the image processing change control of S140.

FIG. 10 is a flowchart of the subroutine of the NR processing of S150.

FIG. 11A is a diagram of the first image in the processing order of the images to be subjected to NR processing.

FIG. 11B is a diagram of the second image in the processing order of the images to be subjected to NR processing.

FIG. 11C is a diagram of the third image in the processing order of the images to be subjected to NR processing.

FIG. 11D is a diagram of the fourth image in the processing order of the images to be subjected to NR processing.

FIG. 12 is a flowchart of the subroutine of the image output processing of S160.

FIG. 13 is a flowchart of the subroutine including the NN redundancy switching processing in the image processing setting of S120.

FIG. 14 is a flowchart executed by an image processing apparatus according to a second embodiment.

FIG. 15 is a flowchart of the subroutine of the image processing change control of S240.

FIG. 16A is an example of an enhancement parameter table of setting values referenced as the next setting values of S2417.

FIG. 16B is an example of a brightness signal addition ratio table of setting values referenced as the next setting values of S2417.

FIG. 16C is an example of a color signal addition ratio table of setting values referenced as the next setting values of S2417.

FIG. 17 is a block diagram illustrating the configuration of an image processing apparatus according to a third embodiment.

FIG. 18 is a flowchart executed by an image processing apparatus according to the third embodiment.

FIG. 19 is a flowchart of the subroutine of the camera parameter obtaining processing of S320.

FIG. 20 is a flowchart of the subroutine of the image processing settings of S330.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The present embodiment will be described below. An image processing apparatus that estimates noise from an input image from a connected camera, uses a neural network (NN) to infer a desired output image, and outputs an inferred image is described as an example in the present embodiment. An image may include a video, a still image, a moving image, an image of one frame of a moving image, and the like. In NN learning, a plurality of pupil images and a corresponding plurality of teacher images are prepared. Next, learning is performed to bring the feature distribution of the pupil images close to the feature distribution of the teacher images so that the network parameters such as weighting, bias, and the like are optimized. In this manner, inferring can be accurately performed even for input images that have not been learnt. By holding the learned parameters obtained via running training a plurality of times in accordance with a camera characteristic, inference can be performed on an input image and an inference image with reduced noise can be obtained.

### First Embodiment

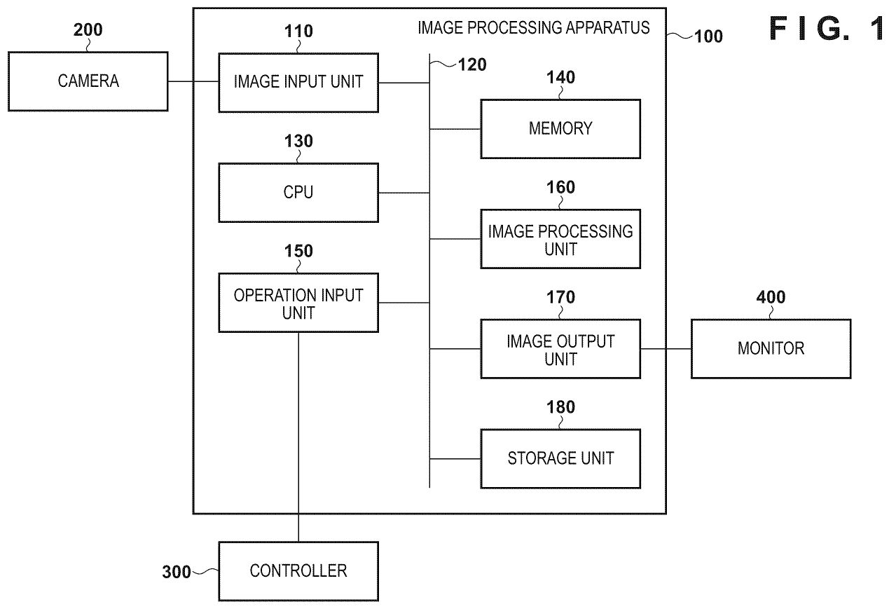

FIG. 1 is a block diagram illustrating the configuration of an image processing apparatus 100. Note that in the present embodiment, an image processing apparatus is used as an example. However, the processing described below can be executed by a video camera with an interchangeable-lens and a camera with an interchangeable-lens such as a single-lens reflex camera or a mirrorless single-lens camera. For example, the processing described below can be executed by a control apparatus in a camera 200 of FIG. 1.

In FIG. 1, the camera 200 captures light incident from a field and generates an image. The camera 200 includes built-in or installable lenses (not illustrated) and includes a zoom lens group, a focus lens group, an iris mechanism, and the like. The camera 200 can change the accumulation time for exposure and can apply gain to a captured image when captured in dark light by an automatic exposure function. The camera 200 sends the captured image to the image processing apparatus 100. The image processing apparatus 100 obtains the image via an image input unit 110.

The image processing apparatus 100 includes the image input unit 110, a bus 120, a CPU 130, memory 140, an operation input unit 150, an image processing unit 160, and an image output unit 170. The image input unit 110, the CPU 130, the memory 140, the operation input unit 150, the image processing unit 160, and the image output unit 170 are connected in a manner allowing the exchange of data via the bus 120. The CPU 130 or the image processing unit 160 execute a program to execute various types of processing such as the image processing executed by the image processing apparatus 100 described below and implement various types of functions. For example, the CPU 130 and image processing unit 160 execute a program to implement functions such as a trained model, a noise reducing unit, a combining unit, a setting unit, an image combining unit, and the like.

The image input unit 110 stores the input image obtained from the camera 200 in the memory 140 or a storage unit 180 via the bus 120.

The operation input unit 150 obtains an operation signal input from a controller 300 external to the image processing apparatus 100. The controller 300 includes a switch, a keyboard, a mouse, a touch panel, and/or the like. The user inputs an operation signal to the image processing apparatus 100 via the controller 300.

CPU is an abbreviation for central processing unit, and the CPU 130 executes various types of processing such as image processing on the basis of programs and parameters stored in the storage unit 180. The CPU 130 executes various types of processing on the basis of operation signals obtained by the operation input unit 150. For example, the CPU 130 executes the setting processing required for image processing executed by the image processing unit 160. The image processing apparatus 100 may include, in addition to the CPU 130, a micro processing unit (MPU), a graphics processing unit (GPU), a quantum processing unit (QPU), or a similar processor.

The memory 140 functions as the working area used by the CPU 130 when executing a program. Also, the memory 140 temporarily stores the parameters and the like required by the CPU 130 when executing a program. The memory 140 may be random-access memory (RAM).

The image processing unit 160 reads out an image stored in the memory 140 or the storage unit 180 and executes various types of processing relating to the image such as the noise estimation processing described below, image signal combining processing, NR processing, UI image generating processing for displaying a user interface (UI), and the like. The image processing unit 160 stores the image obtained by executing various types of processing in the memory 140 or the storage unit 180. The image processing unit 160 may include a processor such as a GPU, for example. Also, the image processing unit 160 may be implemented as a part of the functions of the CPU 130 that executes programs.

The image output unit 170 outputs images held in the memory 140 or the storage unit 180 after being processed by the image processing unit 160 to outside of the image processing apparatus 100. The image output unit 170 outputs an image signal for output from a High-Definition Multimedia Interface (HDMI (registered trademark)) terminal or a serial digital interface (SDI) terminal provided in the image processing apparatus 100.

The storage unit 180 stores programs executed by the CPU 130, parameters required by the programs, and the like. The storage unit 180 stores images obtained from the camera 200, images obtained via image processing by the image processing unit 160, and the like. The storage unit 180 includes a non-volatile storage apparatus such as a hard disk drive (HDD), a solid state drive (SSD), a read-only memory (ROM), or the like.

A monitor 400 receives images output by the image processing apparatus 100 and displays these images. A user such as a picture taker, viewer, or the like can check the captured images of the camera 200, the menu screen of the image processing apparatus 100, post-image-processing images, and the like via the monitor 400. The monitor 400 may be a liquid crystal display device, an organic electro luminescence (EL) display apparatus, or the like, for example.

Note that in FIG. 1, each function is separately illustrated as a component. However, these may be implemented by hardware such as one or more of an application specific integrated circuit (ASIC), programmable logic array (PLA), field programmable gate array (FPGA), and the like. Also, the various functions described above may be implemented by a programmable processor such as a CPU or an MPU executing software.

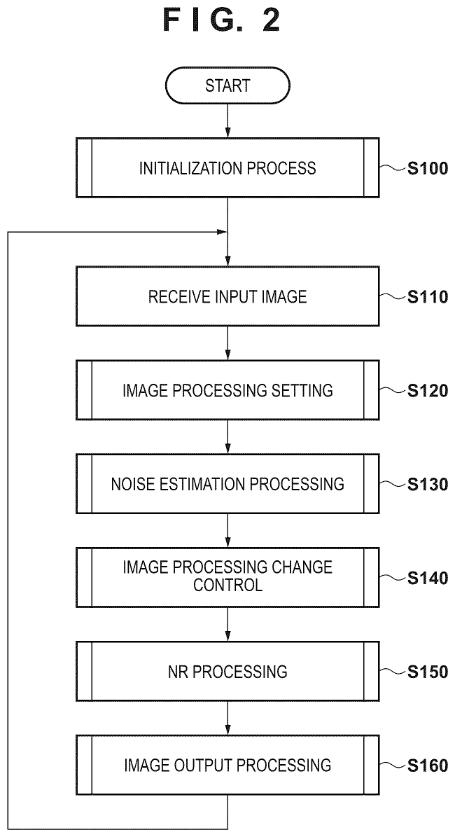

Next, the image processing executed by the CPU 130 in the image processing apparatus 100 will be described using FIG. 2. FIG. 2 is a flowchart of the image processing executed by the image processing apparatus 100. When the image processing apparatus 100 is powered up, the CPU 130 loads a computer program stored in the storage unit 180 and executes the processing in order from S100 of FIG. 2. Note that when the processing up to S160 of FIG. 2 is executed, the CPU 130 executes loop processing from S110 again. The CPU 130 and the image processing unit 160 execute the processing from S110 to S160 for each frame or every few frames of an input image sequentially obtained from the camera 200. Note that either the CPU 130 or the image processing unit 160 executes each item of processing, but the subject that executes the processing may be changed as appropriate.

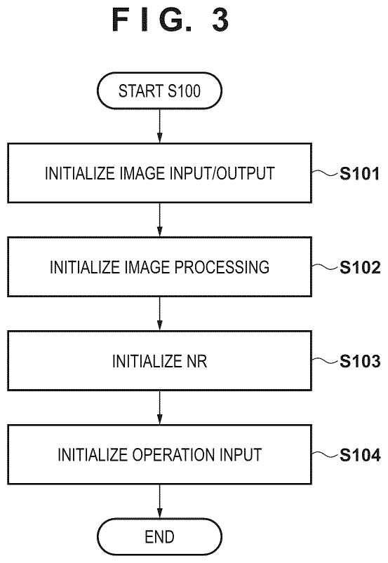

In S100 of FIG. 2, the CPU 130 executes initialization processing of the image processing apparatus 100. FIG. 3 illustrates a flowchart of the subroutine of the initialization processing of S100.

In S101 of FIG. 3, the CPU 130 executes initialization processing for image input/output. The CPU 130 initializes the image input unit 110 and the image output unit 170 so that the image processing apparatus 100 can execute image input/output processing.

In S102, the CPU 130 executes initialization processing for the image processing function. The CPU 130 initializes the image processing unit 160 so that the image processing unit 160 can execute image processing. For example, the CPU 130 sets the initial settings for executing brightness signal combining processing or color signal combining processing for the post-NR-processing image and the input image in the image combining processing described below. For example, when the image processing program starts up, the CPU 130 executes initialization processing and sets the input image add ratio to 100%. The add ratio is a ratio used when combining a brightness signal or a color signal with an inference image.

In S103, the CPU 130 executes NR initialization processing. The CPU 130 loads learnt NN parameters learnt in advance for NR processing executed by the image processing unit 160 and applies them to the trained model of the image processing unit 160. In the present embodiment, various models of the camera 200 that connects to the image processing apparatus 100, image quality of the cameras 200, and similar set states are assumed. The information relating to the various models of the camera 200 and the image quality of the cameras 200 is an example of information relating to the camera 200. The memory 140 or the storage unit 180 holds the learnt NN parameters optimized for each model of the camera 200 and each image quality setting.

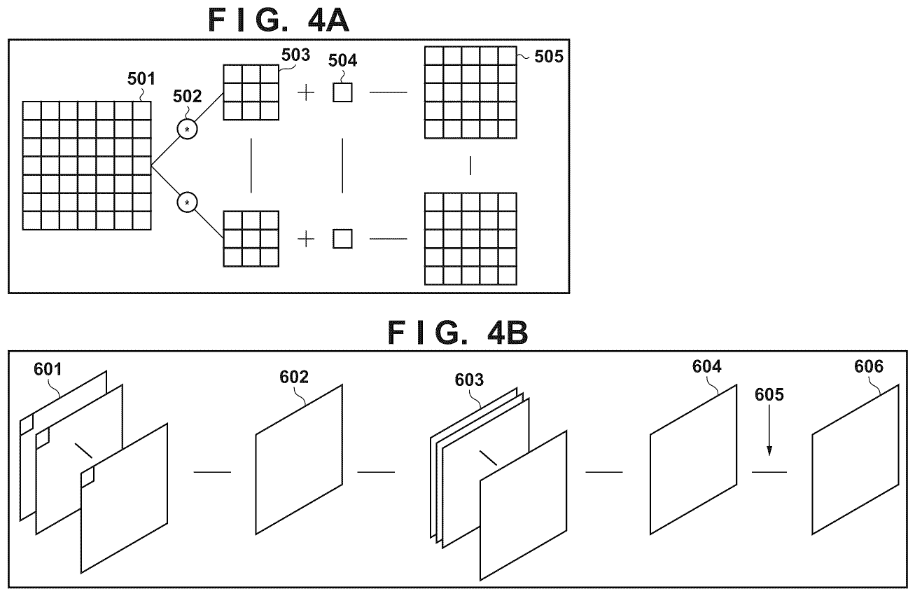

The NN loaded on the image processing unit 160 will now be described using FIG. 4. FIG. 4 is an explanatory diagram of the NN for processing of the input image. A convolution NN (CNN) is used in this example, but the NN of the embodiments is not limited to a CNN. The NN may use a generative adversarial network (GAN) or the like and may include a skip connection or the like. Also, the NN may be a recurrent type such as a recurrent neural network (RNN) or the like.

In FIG. 4A, an input image 501 represents an image input into the NN or a feature map described below. A convolution matrix 503 of FIG. 4A is a filter for performing a convolution operation 502 on the input image 501. A bias 504 is a value added to the result output by the convolution operation 502 of the input image 501 and the convolution matrix 503. A feature map 505 is the convolution operation result after the bias 504 is added to the result output by the convolution operation 502. In FIG. 4, for simplification, the number of neurons, intermediate layers, and channels are reduced, but the number of neurons and layers as well as the number of links between neurons, weighting, and the like are not limited to this example. Also, when the NN illustrated in FIG. 4 is implemented using FPGA, ASIC, or the like, the links between neurons and the weighting may be reduced.

The CNN executes the convolution operation on the input image using a filter to obtain a feature map of the input image. Note that the filter may be any size. In the next layer, a convolution operation is performed on the feature map of the previous layer using a different filter to obtain a different feature map. At each layer, an input signal is multiplied by the filter and the sum with the bias is obtained. Then by applying an activation function to the result, an output signal for each neuron is obtained. The weighting and bias of each layer is referred to as the NN parameters, and in the learning, processing is executed to update the NN parameters. Known examples of an activation function include the sigmoid function, the ReLU function, and the like. In the present embodiment, the Leaky ReLU represented by the following Formula (1) is used, but no such limitation is intended. Note that in Formula (1), max represents a function that outputs the maximum value of the arguments.

$$f ( x ) = max ( x , x \times 0.2 ) \qquad Formula ( 1 )$$

As described above, in pre-training to obtain NN parameters, images with noise characteristics of the camera 200 are used as pupil images, and images corresponding to the pupil images but without noise are used as teacher images. Training is performing using pairs of pupil images and teacher images to implement NR.

Also, the feature map 505 described above is based on the noise of the input image, and the CNN can learn the target regions where a noise component is enhanced by applying a different parameter to the feature map 505. As illustrated in FIG. 4B, the CNN generates an intermediate layer 602 in which the input image 501 is averaged in the channel direction of an input image 601 divided into channels per color, for example. The CNN performs convolution using Formula (1) a plurality of times on the intermediate layer 602 to obtain an intermediate layer 603. Also, the CNN performs convolution so that the output channel becomes a 1 to obtain an attention layer 604. The attention layer 604 is an intermediate layer where a feature amount appears in a noise region without the high frequency component of the subject. The CNN multiplies the attention layer 604 by a noise strength parameter 605 to obtain an attention layer 606 with enhanced noise. By performing convolution on the attention layer 606 and the input image 501 described above together, of the input image 501 and the input image 601, the target degree of the noise region included in the input images can be adjusted, that is, enhanced, and an NN capable of NR processing can be achieved.

Now we will return to the description of FIG. 3. In S104, the CPU 130 executes operation input initialization. The CPU 130 executes initialization processing for input of an operation signal from the controller 300 external to the image processing apparatus 100. Also, the image processing apparatus 100 includes a function enabling an NR function menu to be displayed. The CPU 130 can turn the NR function on or off via user input from the controller 300. Also, the CPU 130 can switch between automatic mode and manual mode for the NR mode setting. In the case of manual mode, an NR strength menu settings screen for setting the NR strength can be displayed. In an example of the present initialization processing, the CPU 130 sets the NR on/off to on and the NR mode setting to automatic mode. After the CPU 130 executes S104, the subroutine S100 ends, and the flow proceeds to S110 of FIG. 2.

In S110 of FIG. 2, the CPU 130 stores the input image received from the camera 200 by the image input unit 110 in the memory 140.

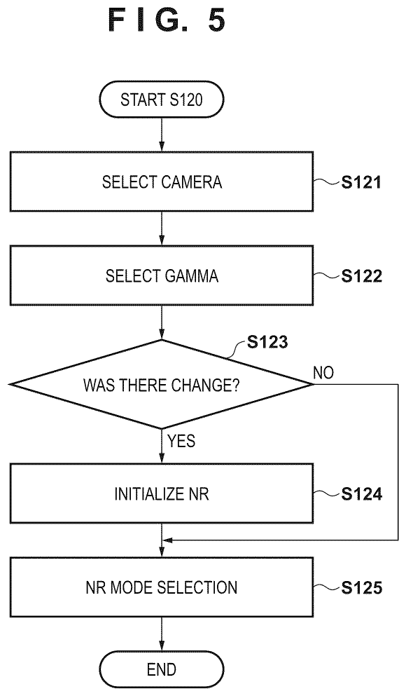

In S120, the CPU 130 sets the image processing settings. FIG. 5 illustrates a flowchart of the subroutine of the image processing settings of S120.

In S121, the CPU 130 selects and sets the model of the camera 200 connected to the image processing apparatus 100 on the basis of the information input via the controller 300 and the operation input unit 150. Note that the CPU 130 may select the model of the camera 200 on the basis of information selected by the user from a settings menu of the image processing apparatus 100 or the like or may select the model of the camera 200 on the basis of information automatically detected from information embedded in the image signal by the image input unit 110.

In S122, as in S121, the gamma applied by the camera 200 connected to the image processing apparatus 100 is selected by the CPU 130. Note that the CPU 130 may select the gamma on the basis of information selected by the user from a settings menu of the image processing apparatus 100 or the like or may select the gamma on the basis of information automatically detected from information embedded in the image signal by the image input unit 110.

In S123, the CPU 130 determines the model of the camera was changed in S121 or whether the gamma selection was changed in S122. In a case where there was a change, the CPU 130 proceeds the flow to S124. In a case where there was no change, the CPU 130 proceeds the flow to S125.

In S124, the CPU 130 loads and sets the learnt NN parameter corresponding to the model of the camera 200 of gamma selected in S121 and S122 in the image processing unit 160. In this manner, the NN described above loaded in the image processing unit 160 corresponds to an NN with an appropriate NN parameter trained in accordance with the connected camera 200 and the gamma settings. In S124, an image for inference using NN, that is, NR processing by the image processing unit 160, is loaded from the memory 140 and put in a processable state.

In S125 of FIG. 5, the CPU 130 selects the NR mode. The CPU 130 selects the NR mode via an operation signal input via a selection menu or the like by a user via the operation input unit 150 from the controller 300. For example, on the basis of an operation signal input by a user, the CPU 130 selects and sets either automatic mode or manual mode for the NR mode. The NR mode processing will be described below in detail in S140 and S150. When the CPU 130 executes S125, the subroutine of S120 ends, and the flow proceeds to S130 of FIG. 2.

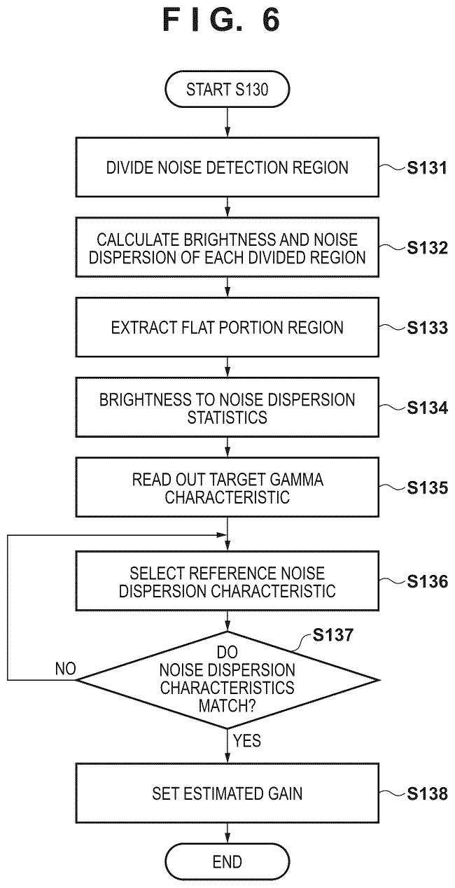

In S130 of FIG. 2, noise estimation processing is executed on the input image obtained in S110 by the image processing unit 160. FIG. 6 illustrates a flowchart of the subroutine of the noise estimation processing of S130.

In S131 of FIG. 6, the CPU 130 sets the input image as a noise detection target region and divides the noise detection target region into blocks. Note that in the present embodiment described herein, the entire input image is set as the noise detection target region. However, the CPU 130 may set a region that is a part of the input image as the noise detection target region. For example, the CPU 130 may set 3×3 pixels as one block in the input image.

Next, in S132, the CPU 130 calculates the brightness and noise dispersion for each block of the divided regions.

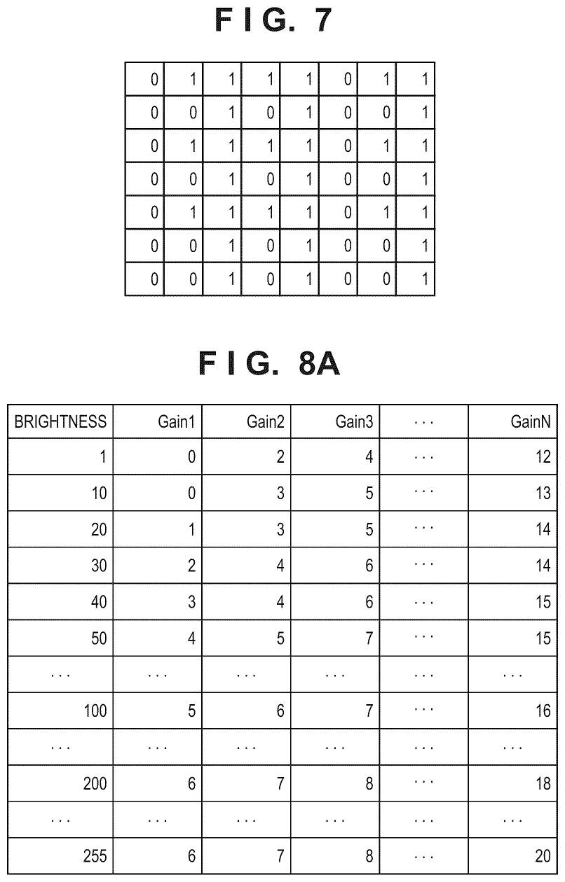

Next, in S133, the CPU 130 extracts a region of a flat portion of the noise dispersion in the noise detection region. FIG. 7 is a diagram for describing an example of flat portion region extraction. Specifically, the CPU 130 extracts the flat portion on the basis of whether or not the noise dispersion value of each block is equal to or less than a threshold. For example, in a case where the noise dispersion of a block is equal to or less than the threshold, the CPU 130 determines it to be a flat portion and sets the block to 1 as illustrated in FIG. 7. On the other hand, in a case where the noise dispersion of a block is greater than the threshold, the CPU 130 determines it not to be a flat portion and sets the block to 0. Note that in a case where the noise dispersion of a block is equal to the threshold, the CPU 130 determines it not to be a flat portion and may set the block to 0. In a case where a brightness difference is included in the texture information of the subject per block unit described above, the brightness difference is calculated as the noise dispersion value, and the CPU 130 has trouble correctly estimating noise.

In S134, the CPU 130 collects the statistical values of the brightness: noise dispersion for only blocks determined to be flat portions and plots the brightness: noise dispersion characteristics. Accordingly, even in a case where a brightness difference is included in the texture information of the subject per block unit described above, the brightness difference can be prevented from being calculated as the noise dispersion value, allowing noise to be estimated with high accuracy by the CPU 130.

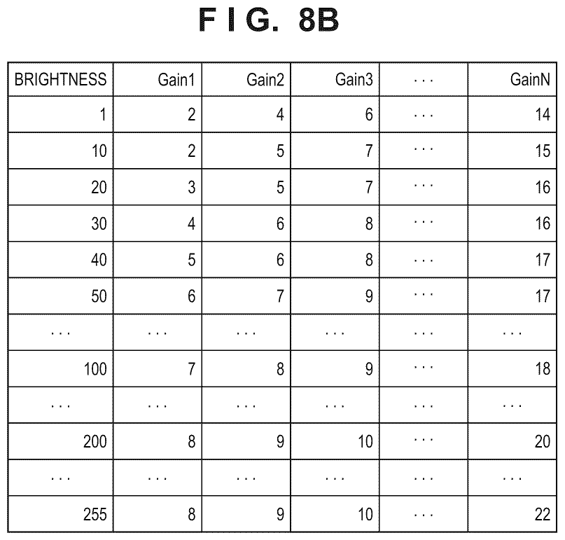

In S135, the CPU 130 loads the noise dispersion characteristic data corresponding to the gamma characteristic currently set. The present noise dispersion characteristic data is stored in the storage unit 180 for estimating the brightness: noise dispersion characteristic for each gain in advance for the model of the connected camera 200 and the set gamma. FIG. 8 is a diagram illustrating an example of the noise dispersion characteristics of different camera 200 settings. For example, the storage unit 180 holds table data including noise dispersion characteristics associated with brightness and gain as illustrated in FIGS. 8A and 8B.

In S136 of FIG. 6, the CPU 130 selects and references the noise dispersion characteristic of each gain in the noise dispersion characteristic table loaded in S135.

In S137, the CPU 130 measures the distance of the noise dispersion characteristic data according to the gain selected in S136 with respect to the dispersion value for each brightness plotted in S134 and performs characteristic match determination. Here, if the value is equal to or less than a discretionary threshold, a match may be determined. In a case where the noise dispersion characteristic is not a match in S137, in other words, is false, the CPU 130 returns to S136, references the noise dispersion characteristic data of the next gain, and performs a noise dispersion characteristic match determination. In S137, if the CPU 130 determines a match, that is, is true, the flow proceeds to S138.

In S138, the CPU 130 estimates the gain determined to have matching noise dispersion characteristics in S136 and S137 as the gain input into the image processing apparatus 100.

With the camera 200, images of various scenes are captured and input into the image processing apparatus 100. The estimation of the noise dispersion characteristic illustrated in FIG. 6 may be ensured by the detection target region having as large an area as possible. With a wider detection target region, the probability of a number of flat portion blocks being detected as described above can be improved. As a result, more information of the dispersion characteristics collected in S134 of FIG. 6 can be obtained.

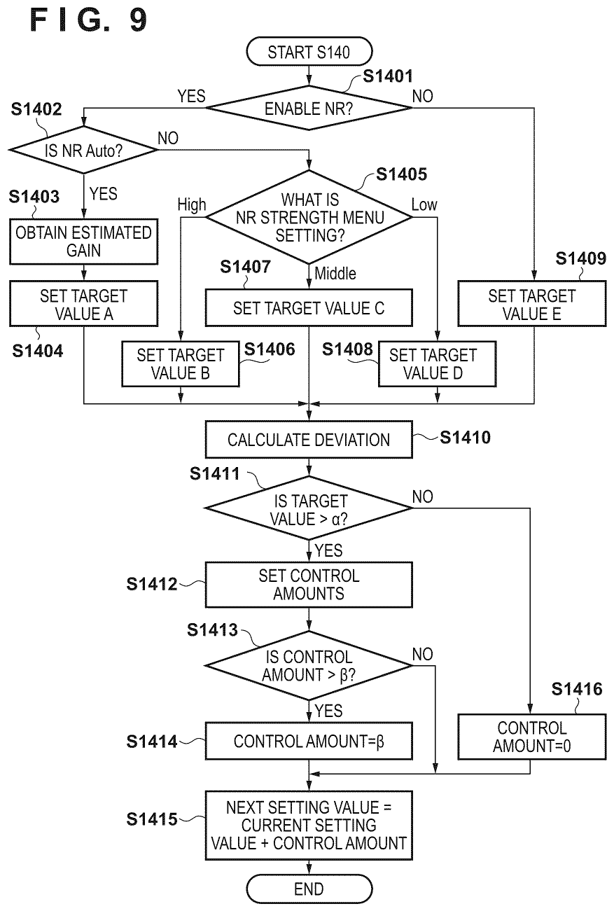

Now we will return to the description of FIG. 6. When the CPU 130 executes S138, the subroutine of S130 of FIG. 6 ends, and the flow proceeds to S140 of FIG. 2. In S140 of FIG. 2, the CPU 130 executes image processing change control. FIG. 9 illustrates a flowchart of the subroutine of the image processing change control of S140.

In S1401 of FIG. 9, the CPU 130 selects to turn the NR on or off. The CPU 130 may select to turn the NR on or off on the basis of an operation signal input by a user or the like via the operation input unit 150 from the controller 300. Also, the CPU 130 may select to turn the NR on or off vi a signal, a command, or the like externally input via a network or the like. In a case where S1401 is YES, that is, the NR is on, the CPU 130 proceeds to S1402. In the case of NO, that is, the NR is off, the CPU 130 proceeds to S1409.

In S1402, the CPU 130 determines the NR mode selected in S125 of FIG. 5. In a case where the determination of S1402 produces a true, that is, the NR mode is the automatic mode, the CPU 130 proceeds to S1403. In the case of false, that is, the NR mode is the manual mode, the CPU 130 proceeds to S1405.

In the case of S1403, that is, the NR mode is the automatic mode, the CPU 130 obtains the gain of the input image estimated in S138 of FIG. 6.

In S1404, the CPU 130 sets a target value A for the case where the NR mode is the automatic mode. The target value A here is a value that is a target for the enhancement parameter applied to the strength parameter 605 of noise of FIG. 4, the brightness signal addition ratio, and the color signal addition ratio. Since higher gain means more noise is included, the CPU 130 sets target value A of the enhancement parameter to a high value in a case where the gain of the estimation of the camera 200 obtained in S1403 is high. On the other hand, in a case where the gain of the estimation is low, the CPU 130 sets the target value A of the enhancement parameter to a low value. Accordingly, the brightness signal addition ratio and the color signal addition ratio are set to low values when the gain of the estimation is high and to high values when the gain of the estimation is low. In particular, when the gain of the camera 200 is high, the color noise may affect the image quality. In this manner, when the gain of the estimation is high, the CPU 130 may not use the color signal addition ratio.

The enhancement parameter will now be described. The noise amount input by the camera 200 and the gamma setting value of the camera 200 is influenced by the set gamma and not the gain. If high gain is estimated, the enhancement parameter is set to a high value, and the CPU 130 can increase the sensitivity to noise so that a higher NR effect is obtained. On the other hand, by setting the enhancement parameter to a low value when low gain is estimated, applying NR more than necessary can be avoided, and as a result, the CPU 130 can reduce negative effects from the NR such as a drop in sharpness, texture defects, and the like.

In S1405, that is, in a case where the NR mode is the manual mode, as in S125 of FIG. 5, the CPU 130 sets the NR strength. For example, the CPU 130 obtains high, middle, and low information selected by the user from an NR strength menu and sets the NR strength. In other words, the NR strength is not an internal value such as the enhancement parameter described above and is selected by the user of the image processing apparatus 100 via a UI or the like. In a case where high is set, the CPU 130 proceeds to S1406 and sets target value B. In a case where middle is set, the CPU 130 proceeds to S1407 and sets target value C. In a case where low is set, the CPU 130 proceeds to S1408 and sets target value D. As with the target value A, the CPU 130 sets the target value B, the target value C, and the target value D for the enhancement parameter, the brightness signal addition ratio, and the color signal addition ratio. This processing is for operating when the NR mode is the manual mode. Thus, the image processing apparatus 100 holds a predetermined parameter for the target value B, the target value C, and the target value D in the storage unit 180 or the like in advance. The target values of the enhancement parameters have the relationship B>C>D. The target values of the brightness signal addition ratio and the color signal addition ratio have the relationship B<C<D. Note that as in S1404 described above, with the target value B, when the gain estimation of the estimation is high, the CPU 130 may not use the color signal addition ratio.

In S1409, that is, when the NR is off, the CPU 130 sets target value E. For example, as the target value E, the CPU 130 sets the enhancement parameter to off and the brightness signal addition ratio and the color signal addition ratio to 100%.

The CPU 130 executes S1404, S1406, S1407, S1408, and S1409 and sets from the target value A to the target value E for each NR operation state. Then the flow proceeds to S1410.

In S1410, the CPU 130 calculates the deviation between the target values described above and the current enhancement parameter, brightness signal addition ratio, and color signal addition ratio.

In S1411, the CPU 130 determines whether the deviation with the target values calculated in S1410 is greater than a threshold α. As described above, the CPU 130 calculates the deviation between the target values and the enhancement parameter, the brightness signal addition ratio, and the color signal addition ratio. Thus, the threshold α may be provided separately for the enhancement parameter deviation, the brightness signal addition ratio deviation, and the color signal addition ratio deviation. In a case where S1411 is true, that is, the deviation of the target value is greater than the threshold α, the CPU 130 determines that the enhancement parameter, the brightness signal addition ratio, and the color signal addition ratio have not reached the target values and the flow proceeds to S1412. In the case of false, the CPU 130 determines that these have sufficiently come close to the target values and proceeds to S1416.

In S1412, the CPU 130 sets the target values, that is, the control amounts for this time for the enhancement parameter, the brightness signal addition ratio, and the color signal addition ratio. In S1412, the control amounts may be set using a method recognized in general control engineering. The control amount is a value added to, from among the enhancement parameter, the brightness signal addition ratio, and the color signal addition ratio, a parameter for change so that it approaches the target value.

In S1413, the CPU 130 determines whether the control amount calculated in S1412 is greater than a threshold β. The threshold β may be any value. The threshold β may be a constant value for each type of state of the NR described above or may increase and decrease in conjunction with the threshold α. In S1412, the control amount calculated by the CPU 130 may be used as is. However, in S1413, the CPU 130 restricts the control amount with respect to one input image so a certain amount, that is, the threshold β, is not exceeded in order to alleviate the amount of image change to the set target value. In a case where S1413 is true, that is, the control amount exceeds the threshold β, the CPU 130 proceeds to S1414. In the case of false, that is, the control amount is equal to or less than the threshold β, the CPU 130 proceeds to S1415.

In S1414, the CPU 130 sets the control amount to the threshold β. In S1416, the CPU 130 sets the control amount to 0.

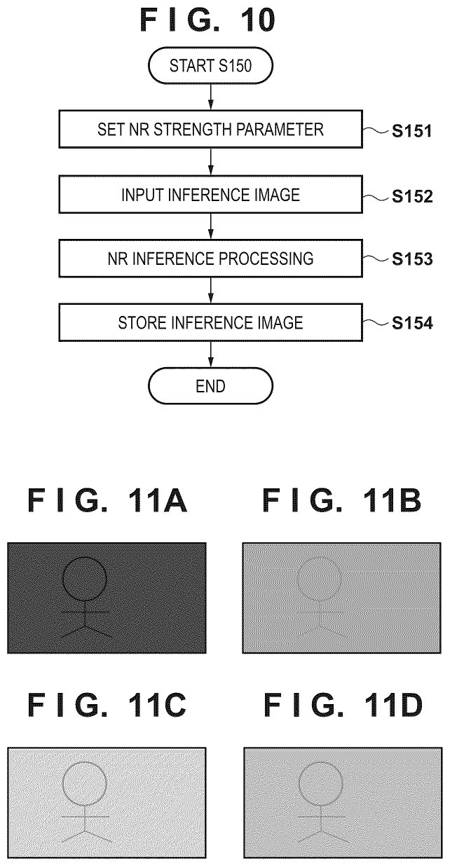

In S1415, the CPU 130 sets, as the next setting value, a value obtained by adding the control amount to each current setting value, that is, the current enhancement parameter, brightness signal addition ratio, and color signal addition ratio, ends the subroutine of FIG. 9, and proceeds to S150 of FIG. 2. Also, the CPU 130 repeats S1415 a plurality of times for the successively obtained input images to add a plurality of control amounts to the enhancement parameter, the brightness signal addition ratio, and the color signal addition ratio. In this manner, the CPU 130 brings the enhancement parameter, the brightness signal addition ratio, and the color signal addition ratio close to the target values. FIG. 10 illustrates a flowchart of the subroutine of the NR processing of S150.

In S151 of FIG. 10, the CPU 130 sets the enhancement parameter set in S1415 of FIG. 9. The enhancement parameter is applied to the strength parameter 605 of the noise described using FIG. 4 and functions as the enhancement parameter to be applied to an attention map based on noise.

In S152, the CPU 130 loads and obtains the image obtained in S110 of FIG. 2 from the memory 140 and inputs the image into the image processing unit 160 for NR inference. FIGS. 11A to 11D are diagrams of the images for NR processing arranged in order of processing. FIG. 11A is an example of an image with dark portions captured by the camera 200. Though hard to see, the image of FIG. 11A includes an image of a person. Since the camera 200 applies gain to the image of FIG. 11A, the image processing apparatus 100 obtains an image including noise as illustrated in FIG. 11B. Thus, the CPU 130 loads and obtains, from the memory 140, an image such as that illustrated in FIG. 11B as the image for NR inference.

In S153, the image processing unit 160 executes NR inference processing.

In S154, the CPU 130 stores, in the memory 140 or the like, the image (inference image) of the result of inference by the image processing unit 160 in S153. The inference image obtained in S153 has reduced noise due to NR inference processing being execute as illustrated in FIG. 11C. When the CPU 130 executes S154, the subroutine of FIG. 10 ends, and the flow proceeds to S160 of FIG. 2.

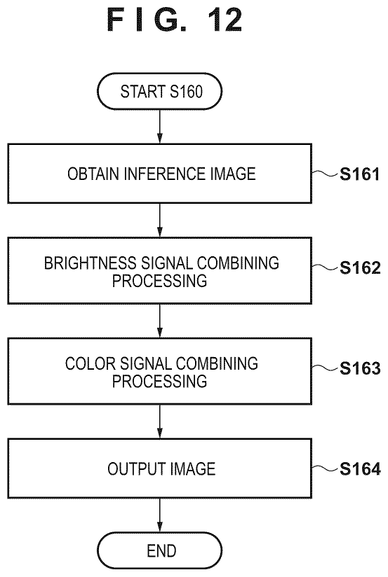

In S160 of FIG. 2, the CPU 130 executes image output processing to output the inference image obtained via NR processing up until S150. FIG. 12 is a flowchart of the subroutine of the image output processing of S160.

In S161 of FIG. 12, the CPU 130 obtains the inference image stored in S154 of FIG. 10.

In S162, the image processing unit 160 executes brightness signal combining processing on the inference image stored in S154. The image processing unit 160 combines the brightness signal with the inference image on the basis of the brightness signal addition ratio corresponding to the next setting value set in S1415 of FIG. 9.

In S163, the image processing unit 160 executes color signal combining processing on the inference image combined with the brightness signal. The image processing unit 160 combines the color signal with the inference image on the basis of the color signal addition ratio set as the next setting value.

In S164, the CPU 130 outputs the image obtained via the combining processing up until S163 by the image processing unit 160 from the image processing apparatus 100 via the image output unit 170 and displays the image on the monitor 400. For example, a portion of the image of FIG. 11B according to the NR mode and strength menu state is combined with the inference image illustrated in FIG. 11C to form the image illustrated in FIG. 11D.

When the CPU 130 executes S164, the subroutine of the image output processing of FIG. 12 ends and the flow returns to the processing of FIG. 2. When the CPU 130 executes S160 of FIG. 2, the flow returns to S110 and the image processing is repeated again.

The CPU 130 repeatedly executes the image processing of FIG. 2 for the target values set by switching the NR between on and off, switching the NR mode between automatic mode and manual mode, and a strength setting change from the menu. This updates S1415 of FIG. 9, allowing the image output in S164 of FIG. 12 to be smoothly changed.

In the example of the embodiment described above, the target values for the enhancement parameter, the brightness signal addition ratio, and the color signal addition ratio are set, the control amount is added, and the next setting values are successively set. However, what the control amount is added to and what is successively set is not limited to that of the example described above. For example, in the present embodiment, an NN parameter may be set with a target value, the control amount may be added to the NN parameter, and the NN parameter may be successively set.

In this manner, in the present embodiment, the target values for the enhancement parameter, the brightness signal addition ratio, and the color signal addition ratio are set by switching the NR between on and off, switching the NR mode between automatic mode and manual mode, a strength setting change from the menu, and the like. The present embodiment provides a method for successively updating the next setting values for the enhancement parameter, the brightness signal addition ratio, and the color signal addition ratio with respect to the set target value on the basis of the control amount per one frame image. Accordingly, the present embodiment can suppress a sudden change in the NR parameters including the enhancement parameter, the brightness signal addition ratio, and the color signal addition ratio, can decrease the shock of an image when a parameter is changed, and can provide a high-quality image with a smooth NR effect applied.

In the present embodiment, the control amount and the threshold β are compared, and when the control amount is greater than the threshold β, the threshold β is set to the control amount. Accordingly, the present embodiment can prevent the control amount exceeding the threshold β and can alleviate change in the enhancement parameter, the brightness signal addition ratio, and the color signal addition ratio that the control amount is added to.

In the present embodiment, the target values are set on the basis of the NR strength selected by the user. Accordingly, in the present embodiment, the user can set the target values as desired, and the image output with the noise removed via the enhancement parameter, the brightness signal addition ratio, and the color signal addition ratio set on the basis of the target values can be as the user desires.

Preferred embodiments according to the present invention have been described above. However, the present invention is not limited to these specific embodiments and include various embodiments without departing from the scope of the claims. Parts of the embodiments described above may be combined as appropriate.

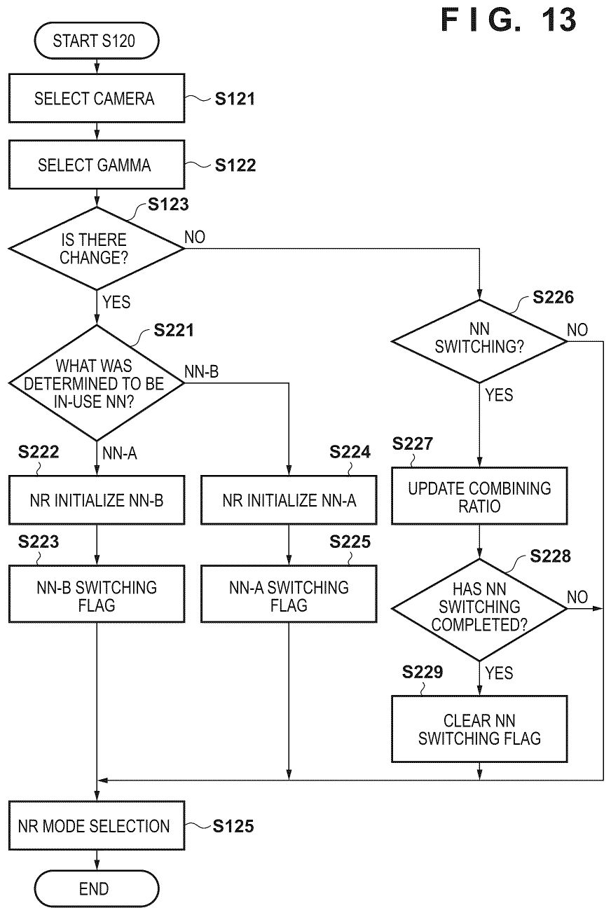

In the description of the embodiment, as illustrated in FIG. 3, in a case where there is a change in the selection of the model of the camera 200 or the selection of the gamma, in S124, the CPU 130 executes NR initialization. Here, the CPU 130 requires time to load the DLNR trained model, which may make smooth NR effect inference difficult. Here, the image processing apparatus 100 may implement the subroutine illustrated in FIG. 13 of the image processing setting of S120 of FIG. 2 by making NN processing redundant. FIG. 13 is a flowchart of the subroutine including the NN redundancy switching processing in the image processing setting of S120. Note that in the description of FIG. 13, description of items similar to that in FIG. 5 will be skipped or abbreviated.

For example, the image processing apparatus 100 may prepare two NN redundancy processing systems, NN-A and NN-B, execute NN processing using either NN-A or NN-B, execute NR initialization using the other NN, and change the NN parameters on the basis of the control amount.

In S123, in a case where the CPU 130 determines that there is a change to the model of the camera 200 or the gamma, as illustrated in S221, whether the in-use NN is the NN-A or the NN-B is determined. If the NN-A is in use, the flow proceeds to S222. If the NN-B is in use, the flow proceeds to S224.

In S222, the CPU 130 performs NR initialization of the NN-B exclusive from the NN-A and continues the NR processing using the NN-A.

In S223, the CPU 130 sets a NN-B switching flag.

In S224 and S225, the CPU 130 executes processing exclusive from S222 and S226. Specifically, in S224, the CPU 130 performs NR initialization of the NN-A exclusive from the NN-B and continues the NN processing using the NN-B. In S225, the CPU 130 sets a NN-A switching flag.

In the following processing from S110 of FIG. 2, false is determined for S123 of FIG. 13, and the flow proceeds to S226.

In S226, the CPU 130 references the switching flag set in S223 or S225 and proceeds to S227 if S226 is true, that is, NN switching is determined. If S226 is false, that is, it is determined to be after NN switching completion, the CPU 130 proceeds to S125.

In S227, the CPU 130 updates the combining ratio, which is the ratio for combining with the NN-B image from the NN-A image or combining with the NN-A image from the NN-B image. Here, the CPU 130 transitions the NN parameters of the NN system for switching to the target values using the predetermined control amount as described using FIG. 9 across a plurality of images and changes them. Thus, the CPU 130 transitions and changes the combining ratio in conjunction with the progress of the transition of the NN parameters being changed. Note that the image processing unit 160 combines the image output from the NN-A and the image output from the NN-B on the basis of the combining ratio.

In S228, CPU 130 determines whether or not NN switching is complete. For example, when the combining ratio indicating the ratio of combining images from one to the other for the NN-A and the NN-B transitions to 100%, the CPU 130 determines true, that is, that NN switching is complete, and proceeds to S229. If it is determined as false, that is, that NN switching is in progress, the CPU 130 proceeds to S125.

In S229, the CPU 130 clears the NN-A switching flag and the NN-B switching flag set in S223 or S225 and proceeds to S125.

NN processing redundancy and the subroutine illustrated in FIG. 13 enable smoother DLNR switching processing. This may also be executed in combination with the switching processing illustrated in FIGS. 9, 11, and 12.

### Second Embodiment

The second embodiment provides a method for pre-storing the next setting values for the enhancement parameter, the brightness signal addition ratio, and the color signal addition ratio with respect to the set target value as a reference table and successively updating them per one frame image.

The configuration of the image processing apparatus 100 according to the second embodiment is the same as the configuration of the first embodiment, that is, the configuration illustrated in FIG. 1, and thus will not be described.

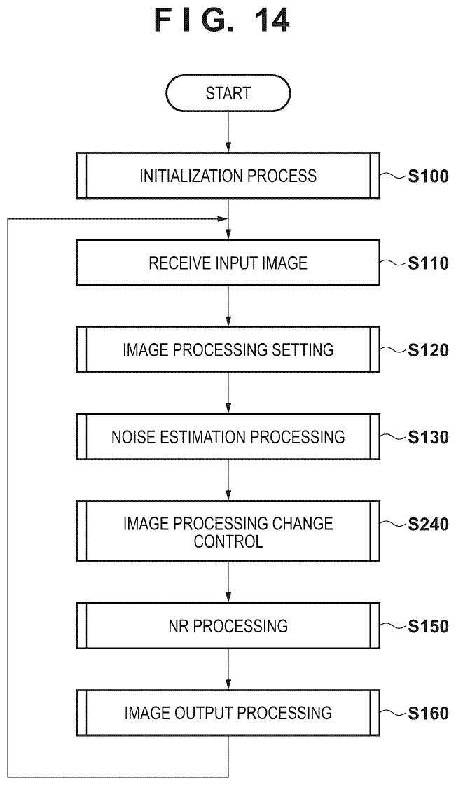

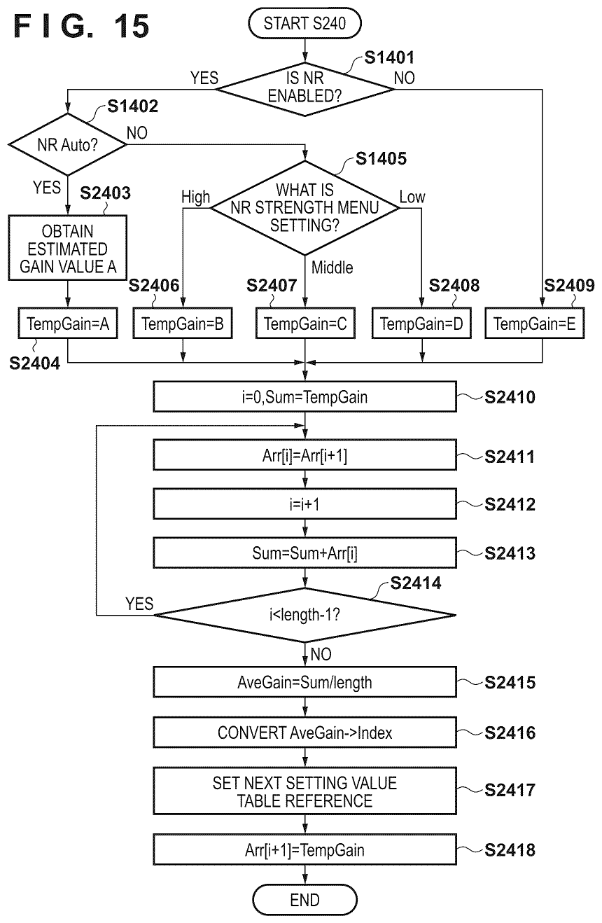

Next, the image processing executed by the CPU 130 in the image processing apparatus 100 will be described using FIG. 14. The processing from S100 to S130 of FIG. 14 that is similar to that of the first embodiment is executed and then proceeds to S240. In S240 of FIG. 14, image processing change control is performed. The subroutine of S240 is illustrated in FIG. 15.

In S1401 of FIG. 15, the CPU 130 selects to turn the NR on or off as in FIG. 9. In a case where S1401 is true, the CPU 130 proceeds to S1402. In the case of false, the CPU 130 proceeds to S2409. In S1402, as in FIG. 9, the CPU 130 determines the NR mode. In a case where S1402 is true, that is, the NR mode is the automatic mode, the CPU 130 proceeds to S2403. In the case of false, that is, the NR mode is the manual mode, the CPU 130 proceeds to S1405. In S2403, the CPU 130 obtains an estimation gain value A of the input image as in S138 and S1403 of the first embodiment and proceeds to S2404.

In S2404, the CPU 130 stores the estimation gain value A in a case where the NR mode is the automatic mode in variable TempGain and proceeds to S2410.

In S1405, that is, in a case where the NR mode is the manual mode, the user of the image processing apparatus 100 operates an external NR strength menu such as a UI and switches the gain value. In a case where the NR strength setting is set to high in accordance with a user selection, the CPU 130 proceeds to S2406 and stores a gain value B in the variable TempGain. In a case where the NR strength setting is set to middle, the CPU 130 proceeds to S2407 and stores a gain value C in the variable TempGain. In a case where the NR strength setting is set to low, the CPU 130 proceeds to S2408 and stores a gain value D in the variable TempGain.

As in the first embodiment, the gain value B to the gain value D are operations in a case where the NR mode is the manual mode. The relationship between the gain values is B>C>D.

A gain value E in S2409, that is, when the NR is off, the CPU 130 is stored in the variable TempGain by the CPU 130. For example, the CPU 130 sets 1 times or 0 dB as the gain value E. Note that the gain value E may be a gain value in a case where typically the gain is low, that is, when NR is not required. Note that the relationship with the gain value D is D>E.

When S2404, S2406, S2407, S2408, and S2409 are executed, the flow proceeds to S2410.

In the present embodiment, for the enhancement parameter, the brightness signal addition ratio, and the color signal addition ratio to transition smoothly, the gain values stored in the variable TempGain are stored in an array Arr. Note that to store the gain values of the most recent frames, the so-called first-in-first-out (FIFO) format is used. This processing will be described below in detail following S2410, but for example, when the array length of the array Arr is 10, the TempGain value updated each frame of the most recent 10 frames is stored. By obtaining the average value of the gain values stored in the array Arr, a gain value applied with a time filter corresponding to the most recent 10 frames. Regarding the gain value stored in TempGain, when the settings are changed or when the NR mode is the automatic mode, the time filter is applied to the change in the noise of the camera to obtain a gain average value that gradually changes. Note that the array length of the array Arr is not limited and may be any array length. Also, the array length of the array Arr is represented as variable length.

In S2410, the CPU 130 initializes an index variable i for referencing the array Arr to 0. A variable Sum for obtaining a total value of the gain values stored in the array Arr is initialized to the value stored in TempGain, that is, the latest gain value.

In S2411, the CPU 130 stores Arr[i+1], which is the i+1-th element of the array Arr, in Arr[i], which is the i-th element of the array Arr. In S2412, the CPU 130 increments the index variable i by 1. In S2413, the CPU 130 adds the gain value stored at the i-th array Arr to the variable Sum. In S2414, the CPU 130 determines whether or not the index variable i is less than the variable length−1 of the array length of the array Arr. In a case where S2414 is true, that is, the CPU 130 determines that the index variable i is less than the variable length−1 of the array length, the flow returns to S2411 and the processing is repeated. In a case where S2414 is false, that is, the CPU 130 determines that the index variable i is not less than the variable length−1 of the array length, and a total value Sum stored in the FIFO processing to the array Arr and the array Arr is calculated, the flow proceeds to S2415.

In S2415, the CPU 130 stores a value obtained by dividing the total value Sum described above by the array length length of the array Arr, that is, the average value of the gain values, in a variable AveGain. In S2416, the CPU 130 converts the variable AveGain into a gain index value for referencing each table of the enhancement parameter, the brightness signal addition ratio, and the color signal addition ratio. In a case where the array length length of the array Arr is 10, for example, the CPU 130 calculates the average value of the gain values of the most recent 10 frames and derives the corresponding gain index value.

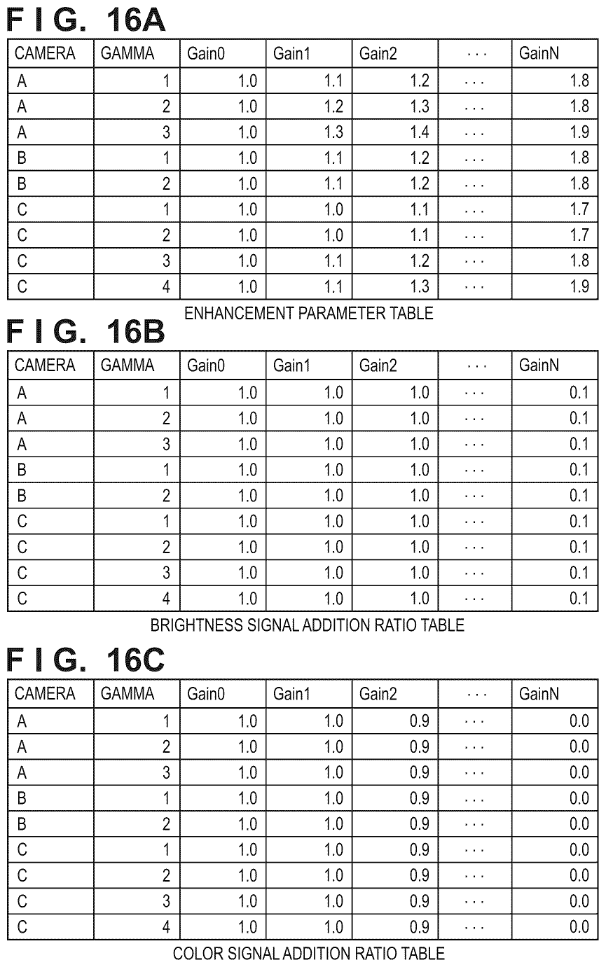

FIG. 16 illustrates an example of each reference table of the setting values reference as the next setting values of the enhancement parameter, the brightness signal addition ratio, and the color signal addition ratio. The reference tables are examples of reference data. FIG. 16A is the enhancement parameter table. FIG. 16B is the brightness signal addition ratio table. FIG. 16C is the color signal addition ratio table. In each row, a parameter for each gain index value for the camera and the gamma are stored. For example, in the enhancement parameter table of FIG. 16A, when the gain value is low, with the enhancement factor set to 1.0, the higher the gain, the higher the value. In a case where, in the brightness signal addition ratio table of FIG. 16B and the color signal addition ratio table of FIG. 16C, the higher the ratio and the lower the gain value, the lower the ratio. Thus, each table may be considered similar to that described in the first embodiment. Each parameter is set in advance so that an optimal NR image quality is obtained on the basis of each gain characteristic for the camera and gamma. Note that the resolution of the gain index value may be per 1 dB, for example. By increasing the resolution, a smoother NR change effect is obtained. However, in the case of a high resolution, since there is a possibility of the memory size of each table increasing, each 3 dB or 6 dB may be used. In S2417, a gain index value conversion mathematical formula corresponding to the resolution of the table is implemented.

Now we will return to the description of FIG. 15. In S2417, the CPU 130 references each reference table described in FIG. 16 on the basis of the table reference index converted in S2416, obtains the enhancement parameter, the brightness signal addition ratio, and the color signal addition ratio, and sets them in the image processing unit 160.

By the CPU 130 repeating S2417 a plurality of times across successively obtained input images, the average value described above can be gradually changed, and the referenced enhancement parameter, the brightness signal addition ratio, and the color signal addition ratio can be gradually brought closer to the target values.

When the CPU 130 executes S2417, the flow proceeds to S2418. In S2418, the CPU 130 stores the TempGain value in Arr[i+1], which is the i+1-th element of the array Arr. In a case where the array length length is 10, the latest gain value is stored in i+1=9, that is, the end of the array Arr.

When the CPU 130 executes S2418, the subroutine of FIG. 15 ends, and the flow proceeds to S150 of FIG. 14. S150 and S160 of FIG. 14 are similar to the processing of S150 and S160 of FIG. 2, and thus a description thereof will be omitted.

In the second embodiment described above, the next setting values of the enhancement parameter, the brightness signal addition ratio, and the color signal addition ratio are pre-stored as reference tables. Also, in the second embodiment, by averaging the gain values obtained per frame for a plurality of frames, that is, applying a time filter, the referenced next setting values can be gradually changed.

### Third Embodiment

In the first embodiment and the second embodiment, via the noise estimation processing described in S130 of FIGS. 2 and 14, the gain values set in the camera 200 are estimated from the noise amount included in an image input into the image processing apparatus 100 from the camera 200. However, in a case where the camera 200 is provided with a communication unit, an image processing apparatus 500 can obtain the camera name, gamma setting, and gain setting of the camera 200. The image processing apparatus 500 that can obtain the setting values itself can accurately obtain the gain value information of the camera 200 and can execute more optimal noise reduction processing.

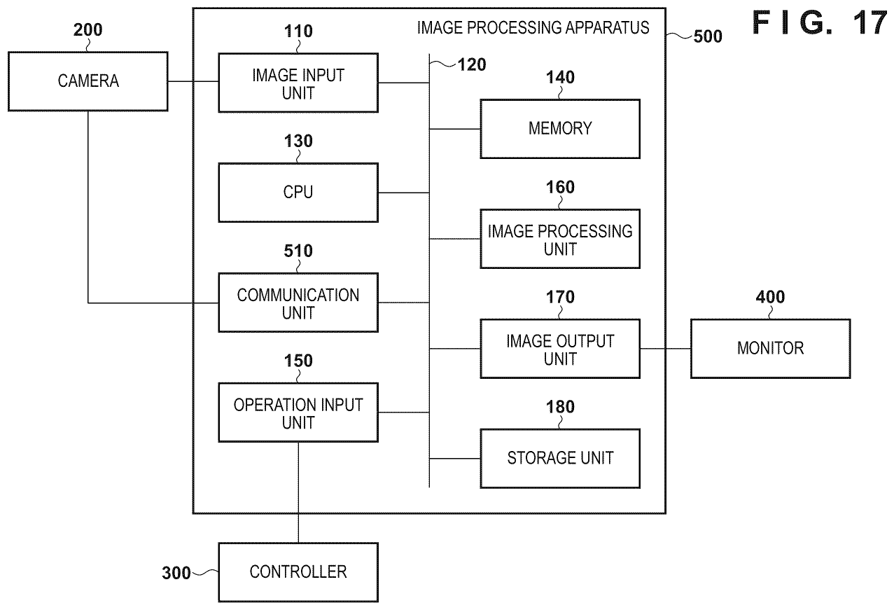

FIG. 17 is a diagram illustrating the configuration of the image processing apparatus 500 according to the third embodiment. The image processing apparatus 500 has the configuration of the image processing apparatus 100 illustrated in FIG. 1 with a communication unit 510 added. The communication unit 510 is connected to the bus 120. The CPU 130 transmits commands compatible with the protocol of the camera 200 via the communication unit 510 to control the camera 200 and obtain the setting values of the camera 200. Ethernet, serial communication, or the like can be used for the physical communication method between the camera 200 and the communication unit 510, but the communication method is not particularly limited. Note that in the case of Ethernet, typically, a protocol using socket communication or a Web API using an http protocol is used. An example of serial communication is a protocol using asynchronous communication. These protocols are also not particularly limited.

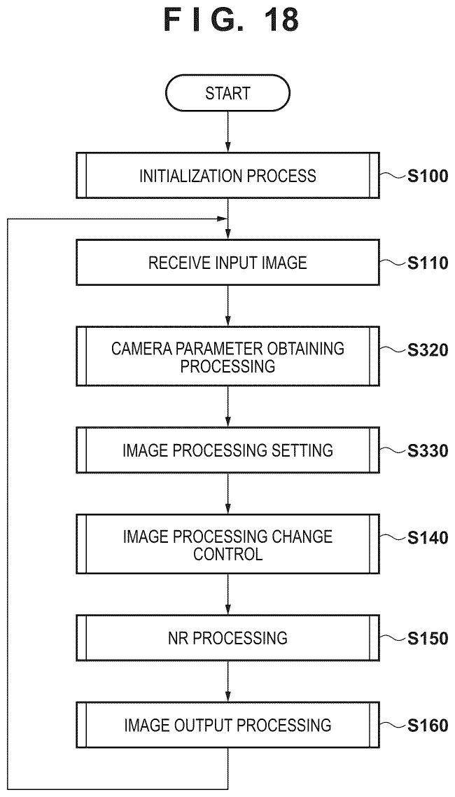

Next, the image processing executed by the CPU 130 in the image processing apparatus 500 will be described using FIGS. 18 to 20. The processing from S100 to S110 of FIG. 18 that is similar to that of the first embodiment is executed by the CPU 130 and then proceeds to S320. In S320 of FIG. 18, the CPU 130 executes camera parameter obtaining processing to obtain camera information. As described above, the CPU 130 obtains setting values and the like of the camera 200 via the communication unit 510 according to the communication protocol of the camera 200.

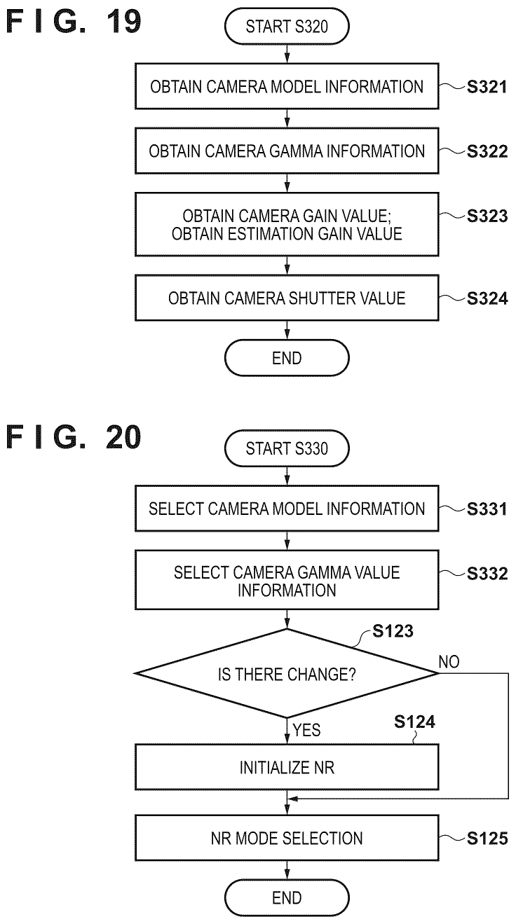

FIG. 19 is a diagram of the subroutine of the camera parameter obtaining processing of S320. In S321 of FIG. 19, the CPU 130 obtains the model information of the camera 200. In S322, the CPU 130 obtains the gamma information currently set in the camera 200. In S323, the CPU 130 obtains the gain value currently set in the camera 200. Also, the obtained gain value is set as the estimated gain value described below. In S324, the CPU 130 obtains the shutter value, that is, the exposure time setting value currently set in the camera 200. When the CPU 130 executes up to S324, the subroutine of FIG. 19 ends, and the flow proceeds to S330 of FIG. 18.

In S330 of FIG. 18, the CPU 130 executes image processing setting.

FIG. 20 is a diagram of the subroutine of the image processing setting of S330 of FIG. 18. From among the steps of the image processing setting of FIG. 20, steps similar to the image processing setting of S120 of FIG. 2 will be only simply described. In S331, the CPU 130 selects the model information of the camera obtained in S321 of FIG. 19. In S332, the CPU 130 selects the information of the gamma value selected in the camera 200 obtained in S322 of FIG. 19. In the first embodiment and the second embodiment described above, the user or the like selects the information of the camera and the gamma value of the camera from a menu or the like of the image processing apparatus 100. However, in the present embodiment, the CPU 130 selects the information of the camera and the gamma value obtained via communication from the camera 200. Thus, the NR setting values are automatically selected according to the setting value of the gamma value of the connected camera 200. When the CPU 130 executes S332, the flow proceeds to S123. The processing executed from S123 to S125 is similar to that described in the first embodiment, and thus description thereof will be omitted. When the connected camera 200 is changed or the gamma value information of the camera 200 is changed, in the present subroutine, the CPU 130 automatically executes NR initialization. When the CPU 130 executes the NR mode selection processing of S125, the subroutine of FIG. 20 ends, and the flow proceeds to S140 of FIG. 18.

The processing executed in S140 of FIG. 18 is similar to that described in the first embodiment executed by the CPU 130, and thus description thereof will be omitted. Note that S140 according to the present embodiment and S240 described using FIG. 14 according to the second embodiment may be substituted for one another, and still the following processing is executed in a similar manner.

The processing executed in S150 and S160 of FIG. 18 is similar to that described in the first embodiment, and thus description thereof will be omitted.

In the third embodiment, processing similar to that of the embodiments described above can be executing by obtaining the setting value information directly from the camera 200.

Preferred embodiments according to the present invention have been described above. However, the present invention is not limited to these specific embodiments and include various embodiments without departing from the scope of the claims. Parts of the embodiments described above may be combined as appropriate.

Note that in the present embodiment described herein, an image from the camera is input into the image processing apparatus. However, the present invention can be implemented using a configuration in which it is input from an image output apparatus other than a camera.

A software program for implementing the functions of the embodiments described above being supplied to a system or an apparatus including a computer capable of executing the program directly from a recording medium or via wired or wireless communication and being executed is also included in the present invention.

Accordingly, because the functional processing of the present invention is implemented using a computer, a program supplied to the computer and installed also may implement the present invention. In other words, a computer program for implementing the functional processing of the present invention is included in the present invention.

In this case, as long as the functions of the program are provided, the object code, the program executed by the interpreter, the script data supplied to the OS, or any similar program form can be used.

For the recording medium for supplying the program, for example, a magnetic recording medium such as a hard disk or magnetic tape, an optical or magneto-optical recording medium, or a non-volatile semiconductor memory may be used.

Also, a plausible method for supplying the program includes storing the computer program for implementing the present invention on a server on a computer network and a connected client computer downloading the computer program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2023-166226, filed Sep. 27, 2023, and 2024-090281, filed Jun. 3, 2024 which are hereby incorporated by reference herein in their entirety.

What is claimed is:

1. An image processing apparatus comprising:
one or more memories storing instructions; and
one or more processors executing the instructions to:
execute image processing of an obtained input image via a trained model including a first parameter obtained by training on an image noise characteristic,
reduce noise of an input image subjected to the image processing via a second parameter,
combine the input image and an input image with the noise reduced on a basis of a third parameter, and
in a case of changing one of the first parameter, the second parameter, and the third parameter, change and set a parameter to be changed on a basis of one of a control amount and preset reference data across a plurality of input images successively obtained.

2. The image processing apparatus according to claim 1, wherein
the first parameter is a parameter of a neural network of a result of training on a noise characteristic in information relating to a camera that captured the input image.

3. The image processing apparatus according to claim 1, wherein
the second parameter is a parameter indicating a strength of reducing the noise.

4. The image processing apparatus according to claim 1, wherein
the third parameter is a ratio for combining the input image with the noise reduced and the input image.

5. The image processing apparatus according to claim 1, wherein
the third parameter is a ratio for combining a brightness signal of the input image with the noise reduced and a brightness signal of the input image.

6. The image processing apparatus according to claim 1, wherein
the third parameter is a ratio for combining a color signal of the input image with the noise reduced and a color signal of the input image.

7. The image processing apparatus according to claim 6, wherein
in setting the parameter to be changed, the ratio for combining the color signals is lower when the noise of the input image is greater.

8. The image processing apparatus according to claim 1, wherein
in the image processing, in a case where two systems of trained models based on the first parameter are provided and a first trained model is in-use, the first parameter of a second trained model is changed using the control amount across a plurality of input images,
and the one or more processors further execute the instructions to
combine, on a basis of a combining ratio, an input image output with noise reduced after image processing by the first trained model and an input image output with noise reduced by the noise reducing unit after image processing by the second trained mode.

9. The image processing apparatus according to claim 8, wherein
in the combining, the image is combined on a basis of the combining ratio that transitions in conjunction with transition progress of the first parameter being changed.

10. The image processing apparatus according to claim 1, wherein
in setting the parameter to be changed, the control amount is set and the parameter is changed so that the second parameter and the third parameter approach a target value of the parameter to be changed.

11. The image processing apparatus according to claim 10, wherein
in setting the parameter to be changed, in a case where one of the first parameter and the target value is to be changed, the first parameter, the second parameter, and the third parameter are changed on a basis of the control amount.

12. The image processing apparatus according to claim 10, wherein
in setting the parameter to be changed, the control amount and a threshold are compared and in a case where the control amount is greater than the threshold, the threshold is set as the control amount.

13. The image processing apparatus according to claim 12, wherein
in setting the parameter to be changed, the target value is set according to a strength of reducing the noise selected by a user.

14. The image processing apparatus according to claim 1, wherein
in setting the parameter to be changed, at least one of the second parameter and the third parameter is obtained from pre-stored reference data and set.

15. The image processing apparatus according to claim 14, wherein
in setting the parameter to be changed, at least one of the second parameter and the third parameter is obtained from the reference data on a basis of an average value of gain values of images of a plurality of frames.

16. The image processing apparatus according to claim 1, wherein
in setting the parameter to be changed, at least one of the second parameter and the third parameter is set on a basis of information relating to a camera obtained from a camera that captured the input image.

17. An image processing method comprising:
executing image processing of an obtained input image via a trained model including a first parameter obtained by training on an image noise characteristic;
reducing noise of an input image subjected to the image processing via a second parameter;
combining the input image and an input image with the noise reduced on a basis of a third parameter; and
in a case of changing one of the first parameter, the second parameter, and the third parameter, changing and setting a parameter to be changed on a basis of a control amount across a plurality of input images successively obtained.

18. A non-transitory computer-readable storage medium storing a computer program that when read and executed by a computer, causes the computer to
execute image processing of an obtained input image via a trained model including a first parameter obtained by training on an image noise characteristic;
reduce noise of an input image subjected to the image processing via a second parameter;
combine the input image and an input image with the noise reduced on a basis of a third parameter; and
in a case of changing one of the first parameter, the second parameter, and the third parameter, change and set a parameter to be changed on a basis of a control amount across a plurality of input images successively obtained.
